(19) United States
(12) Patent Application Publication
(10) Pub. No.: US 2009/0141491 A1
(43) Pub. Date: Jun. 4, 2009

(54) Inflatable Lighting and Display Apparatuses and Systems

(76) Inventor: Chun Kit Sidney Chu, Hong Kong (CN)

Correspondence Address: EAGLE IP LIMITED, 22/F., KWAI HUNG HOLDINGS CENTRE, 89 KING'S ROAD, NORTH POINT, HK

(21) Appl. No.: 12/364,501

(22) Filed: Feb. 2, 2009

Related U.S. Application Data
(63) Continuation-in-part of application No. 11/446,148, filed on Jun. 5, 2006.
(60) Provisional application No. 60/688,703, filed on Jun. 9, 2005.

(51) Int. Cl. F21V 9/00; B60Q 1/00

(52) U.S. Cl. 362/231; 362/227

(57) ABSTRACT

The present invention discloses a inflatable apparatus to provide inflatable display to external viewers. The present invention, in one aspect, is an inflatable lighting apparatus includes an inflatable structure, a plurality of light sources disposed on the exterior of the inflatable structure, and at least one mixing device. The mixing device mixes light emitted by the plurality of light sources. The inflatable apparatus provides indirect viewing for a viewer and each light source represents a pixel in video display. By providing the indirect viewing, even the viewer is close to the light apparatus, the pixel will be shown as a single color dot to the viewer. A system consists of a plurality of inflatable lighting apparatus is also disclosed.

### CROSS-REFERENCE TO RELATED APPLICATION

This application is a continuation-in-part of U.S. Ser. No. 11/446,148, filed on Jun. 5, 2006, which claims benefit of prior provisional application Ser. No. 60/688,703, filed on Jun. 9, 2005, both of which are hereby incorporated by reference herein in their entirety.

### FIELD OF INVENTION

The present invention relates to inflatable lighting apparatuses and also to lighting and display systems comprising multiple interconnected inflatable light apparatuses.

### BACKGROUND OF INVENTION

Lighting and display apparatuses and systems, particularly of the outdoor type, require some kind of structure for mounting and support purposes. Existing structures may not be in an optimal or desirable position and/or may be inconvenient for mounting and supporting a lighting or display system. An additional problem is that large lighting and display systems have considerable weight and thus require substantial support for deployment.

Consequently, there is a need for lighting and display apparatuses and systems that require less substantial mounting and supporting arrangements.

### SUMMARY OF INVENTION

Aspects of the present invention provide apparatuses and systems for lighting and displays.

A first aspect of the present invention provides an apparatus comprising an inflatable balloon and a light source externally coupled to the balloon. The apparatus is adapted to float when the balloon is inflated with a volume of gas having less weight than an equivalent volume of air.

Another aspect of the present invention provides an apparatus comprising an inflatable balloon made from a translucent material and a light source disposed internally in the balloon. The apparatus is adapted to float when the balloon is inflated with a volume of gas having less weight than an equivalent volume of air. The light source derives power from a power source located externally to the balloon.

Another aspect of the present invention provides an apparatus comprising an inflatable balloon and a plurality of optical fibers disposed internally in the balloon. The apparatus is adapted to float when the balloon is inflated with a volume of gas having less weight than an equivalent volume of air.

Another aspect of the present invention provides an inflatable system comprising a plurality of inflatable balloons and a plurality of light sources each coupled to an inflatable balloon. The light sources are adapted to float when the inflatable balloons are inflated with a volume of gas having less weight than an equivalent volume of air.

Another aspect of the present invention provides an inflatable system comprising a plurality of interconnected light sources each coupled to an inflatable balloon. The light sources are adapted to float when the inflatable balloon is inflated with a volume of gas having less weight than an equivalent volume of air.

Another aspect of the present invention provides an inflatable umbrella comprising at least one inflatable compartment, a handle for carrying the umbrella and a plurality of light sources attached to the inflatable compartment. The umbrella is adapted to float when the at least one inflatable compartment is inflated with a volume of gas having less weight than an equivalent volume of air.

Another aspect of the present invention provides a system comprising an inflatable compartment and a plurality of light sources coupled to the inflatable compartment. The light sources are supported in an operational configuration by the inflatable compartment only while the inflatable compartment is continuously inflated.

Embodiments according to various aspects of the present invention comprise red, green and blue light emitting diodes or red, green and blue optical fibers as light sources. The output intensity of the red, green and blue light sources is individually controllable to generate light of a selectable color using RGB color mixing.

Certain of the embodiments also comprise a color mixing chamber for mixing light of various colors generated by the light sources. The color mixing chamber may comprise a reflective surface and/or an optical lens adapted to transmit light reflected by the reflective surface. The color mixing chamber may also comprise a brightness enhancement film for enhancing the brightness of light generated by the light sources in a particular viewing axis.

### BRIEF DESCRIPTION OF FIGURES

Embodiments are described hereinafter, by way of example only, with reference to the accompanying drawings in which:

FIG. 1 is a perspective drawing of an inflatable apparatus comprising a light source according to an embodiment of the present invention;

FIG. 2a is a perspective drawing of an inflatable apparatus comprising a light source according to another embodiment of the present invention;

FIG. 2b is a perspective drawing of an inflatable apparatus comprising a light source according to another embodiment of the present invention;

FIG. 2c is a perspective drawing of an inflatable apparatus comprising a light source according to another embodiment of the present invention;

FIG. 3a is a perspective drawing of an inflatable apparatus comprising a light source according to another embodiment of the present invention;

FIG. 3b is a sectional bottom view of the inflatable apparatus of FIG. 3a;

FIG. 4 is a perspective drawing of an inflatable apparatus comprising a light source according to another embodiment of the present invention;

FIG. 5a is a perspective view of an inflatable lighting system according to an embodiment of the present invention;

FIG. 5b is a perspective view of an inflatable display system according to another embodiment of the present invention;

FIG. 6a is a perspective view of an inflatable lighting system according to an embodiment of the present invention;

FIG. 6b is a perspective view of an inflatable display system according to another embodiment of the present invention;

FIG. 6c is a cross-sectional side view of the inflatable display system of FIG. 6b;

FIG. 6d is a perspective view of an inflatable display system according to another embodiment of the present invention;

FIG. 7a is a perspective view of an inflatable lighting system according to an embodiment of the present invention;

FIG. 7b is a perspective view of an inflatable display system according to another embodiment of the present invention;

FIG. 8 is a perspective view of an inflatable lighting system according to an embodiment of the present invention;

FIG. 9 is a perspective view of an inflatable umbrella in accordance with an embodiment of the present invention;

FIG. 10 is a diagram showing inductive coupling of power to light sources external to an inflatable balloon;

FIG. 11a is a perspective view of an inflatable lighting or display system according to another embodiment of the present invention; and

FIG. 11b is a perspective view of an inflatable lighting or display system according to another embodiment of the present invention.

FIG. 12 is a perspective view of an inflatable lighting or display system according to another embodiment of the present invention.

### DETAILED DESCRIPTION OF THE PREFERRED EMBODIMENTS

Apparatuses and systems are described herein for providing lighting and displays, including full color video image displays.

Embodiments described herein are described with reference to inflatable balloons. The scope of the phrase “inflatable balloon”, in the context of the present specification, is intended to include any “air-sealed” compartment or pocket. In order that such balloons may be made to float, the balloons are inflated with a gas of weight less than that of an equivalent volume of air. One preferred such gas is helium. The physical size of the inflatable balloons is dependent upon the weight of the light source/s and associated items required to be supported when the balloon floats. The inflatable balloons may be inflated with a pump or compressor. Alternatively, automatic inflation is possible using an inflation device such as a pressurized helium canister. Automated deflation is also possible, with helium released from the inflatable balloons being re-pressurized in the canister. In other embodiments, gas from an external gas source is pumped by an external gas pump through one or more tube/s to inflate and/or deflate the balloons. For example, gas may be continuously pumped through an interconnected array or network of inflatable balloons.

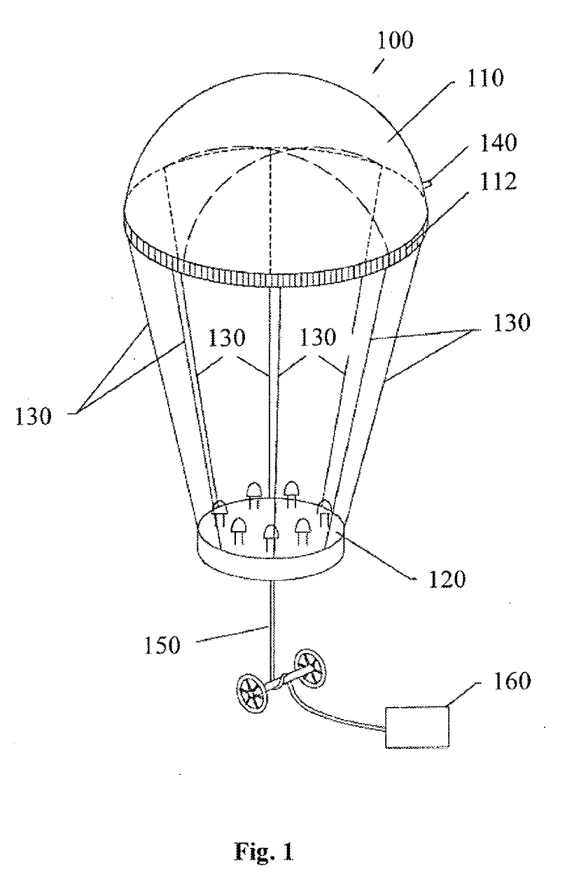

Embodiments described hereinafter comprise light sources. One such light source comprises one or more light emitting diodes (LEDs). Advantageous attributes of LEDs compared to other light sources include low energy consumption (e.g., 10% of the energy consumed by an incandescent light of comparable output), long lifetime (e.g., 100,000 hours) and lightness in weight. Another such light source comprises one or more optical fibers. Optical fibers are advantageously light in weight and are thus also well-suited to embodiments of the present invention. Examples of optical fibers that may be used are polymer optical fiber (POF) and glass optical fiber. Embodiments described hereinafter include either LEDs or optical fibers as light sources. However, LEDs and optical fibers may be used interchangeably in each embodiment with appropriate driving arrangements. For example, the light sources shown in FIGS. 1, 2a, 2b, 3a, 3b and 4 may comprise optical fibers.

Certain embodiments described hereinafter include a light or color mixing chamber, which comprises a chamber or volume having reflective wall surfaces. Light generated by light sources of various colors is reflected off the reflective wall surfaces for color mixing to produce light of relatively more uniform color and brightness. The color mixing chamber may further comprise a diffusion means such as a lens or filter. An example of such a diffusion filter is Brightness Enhancement Film (BEF), which typically comprises a thin micro-replicated prismatic structured film that redirects light and increases brightness in a particular viewing axis (similar to a polarizing filter). Use of BEF with a light source can thus result in increased brightness and/or power savings.

FIG. 1 shows an apparatus 100 comprising an inflatable balloon 110 in an inflated state to which a light source 120 is coupled by means of lines 130. The light source 120 may be suspended below the balloon 110 as shown in FIG. 1. A port 140 is provided for inflation and deflation of the balloon 110. The inflatable balloon 110 comprises a helium-filled balloon and the light source 120 comprises a number of LEDs, which are typically mounted on an electronic circuit board. However, other forms of mounting may alternatively be employed.

The underside of the balloon 110 provides a reflective surface 112 for reflecting light generated by the light source 120. The reflective surface 112 in FIG. 1 is shown to assume a concave shape, which assists in focusing the light generated by the light source 120. Alternatively, the reflective surface may be adapted to assume a convex shape, which assists in dispersing the light generated by the light source 120. The light source is preferably directional such that a substantial percentage of light generated is reflected by the reflective surface 112. The reflective surface 112 may comprise a highly reflective coating applied to the external surface of the balloon 110. Alternatively, the entire balloon 110 may be produced from a reflective material. Alternatively, the reflective surface may not form part of the balloon 110, but may be provided separately from the balloon 110 for reflection of light generated by the light source 120.

The light source 120 may be powered by means of a power cable 150 coupled at a proximal end thereof to the light source 120 and at a distal end thereof to a power supply 160. The power supply 160 may provide power from the electricity supply, typically via a step-down transformer, from batteries, or from solar cells. Alternatively, the light source 120 may be powered by solar cells mounted on or adjacent to the balloon 110 or by batteries located at the light source 120.

The apparatus 100 is restrained from floating away by means of the power cable 150, which acts as a tether line. The height above the ground of the apparatus 100 may be varied by adjusting the length of the power cable 150 to illuminate a desired area below the apparatus 100.

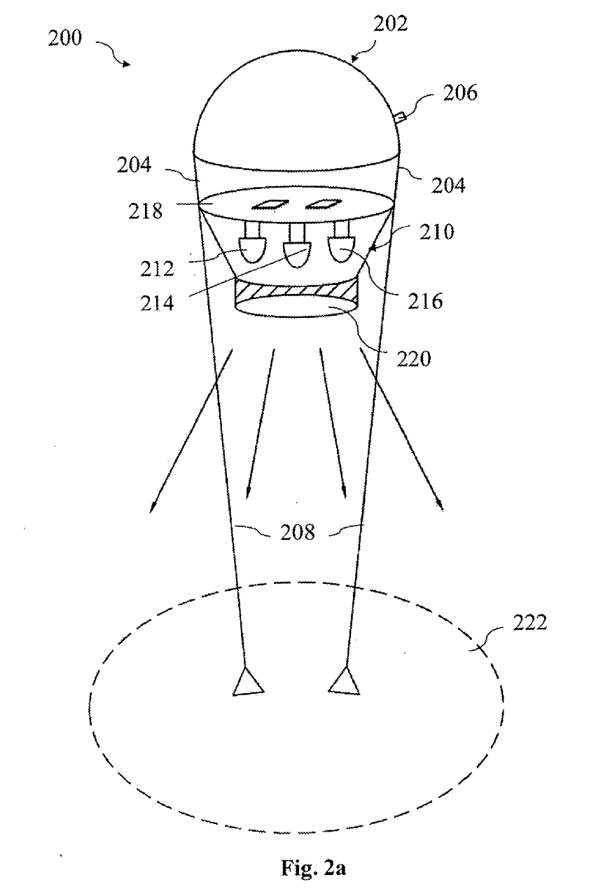

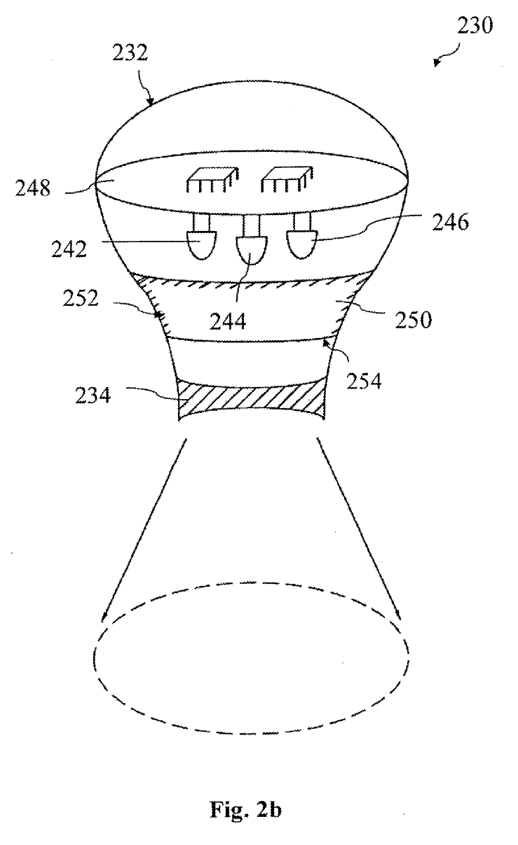

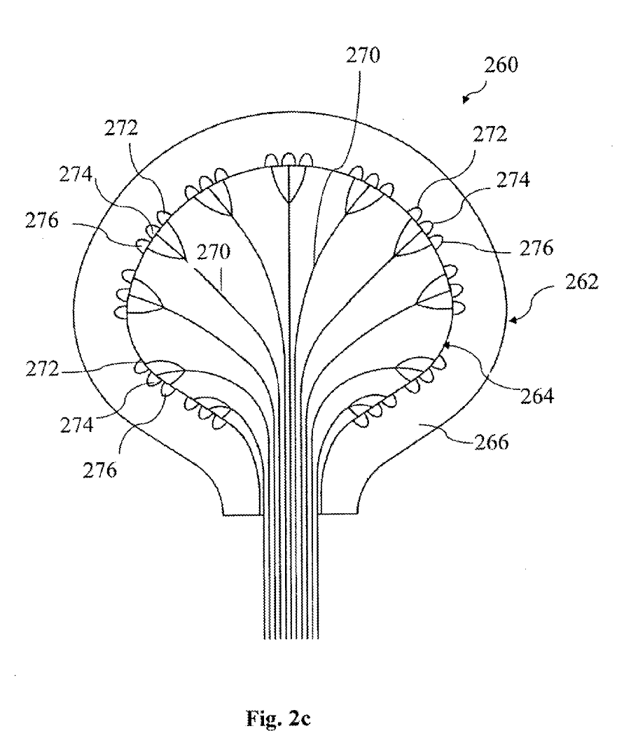

FIG. 2a shows an apparatus 200 comprising an inflatable balloon 202 in an inflated state to which a light source 210 is coupled by means of lines 204. A port 206 is provided for inflation and deflation of the balloon 202. The inflatable balloon 202 comprises a helium-filled balloon and the light source 210 optionally comprises a color or light mixing chamber. The color mixing chamber 210 comprises at least one red LED 212, one green LED 214 and one blue LED 216 for RGB color mixing to generate light of a particular color, including white light. Almost any color in the spectrum may be generated by varying the intensity of the individual RGB colors. Clusters or distributed combinations of LEDs of each of the RGB colors are typically used for increased light intensity. Mixing of light generated by the red, green and blue LEDs 212, 214 and 216 is performed by an electronic mixing circuit, whose electronic components are mounted with the LEDs on an electronic circuit board 218. Alternatively, the electronic mixing circuit may be located externally to the apparatus 200. The color mixing chamber 210 further comprises an optical lens 220 for focusing or dispersing light generated by the LEDs in the color mixing chamber 210.

The apparatus 200 is restrained from floating away by means of tether lines 208. The height above the ground of the apparatus 200 may be varied by adjusting the length of the tether lines 208 to illuminate a desired area 222 below the apparatus 200 based on the focal length of the optical lens 220.

Power for operating the LEDs is delivered to the color mixing chamber 210 by means of a power cable coupled at a proximal end thereof to the color mixing chamber 210 and at a distal end thereof to a power source (not shown) such as the electricity supply (typically via a step-down transformer), batteries, or solar cells. The power cable may be routed along the tether lines 208. Alternatively, the tether lines 208 may comprise electrical conductors and thus act as a power cable for delivering power to the color mixing chamber 210. Alternatively, the color mixing chamber 210 may be powered by solar cells mounted on or adjacent to the balloon 202 or by batteries located at the color mixing chamber 210 (i.e., for low power and/or short duration applications).

FIG. 2b shows an apparatus 230 comprising an inflatable balloon 232 in an inflated state. A light source, which comprises at least one red LED 242, one green LED 244 and one blue LED 246 for RGB color mixing is disposed within the inflatable balloon 232. Mixing of light generated by the red, green and blue LEDs 242, 244 and 246 is performed by an electronic mixing circuit, whose electronic components are mounted with the LEDs on an electronic circuit board 248.

The apparatus 230 optionally comprises a color mixing chamber 250, as shown in FIG. 2b. A portion 252 of the interior surface of the inflatable balloon 232, which forms part of the color mixing chamber 250, may be coated with a highly reflective material for reflecting light from the light source through a Brightness Enhancement Film (BEF) 254, as described hereinbefore, and an optical lens 234 for focusing or dispersing light generated by the LEDs in the color mixing chamber 250. Other aspects of the apparatus 230 such as the tether lines, inflation/deflation port and various alternative power supply arrangements are as described hereinbefore in relation to the apparatus 200 of FIG. 2a.

FIG. 2c shows an apparatus 260 comprising an inflatable balloon 262 in an inflated state, within which a number of optical fibers 270 are disposed. The ends of the optical fibers 270 are held in place or located by an inner structure 264. The inner structure 264 may, for example, be made from a material such as polyvinylchloride (PVC), polyethylene (PE), polycarbonate (PC) or acrylic material. The shape of the inner structure 264 may be maintained or improved by a light-weight frame that is slightly elastic in nature, for example, made from light metal wires or polymer wires such as Nylon. The ends of the optical fibers 270 comprise red, green and blue light sources 272, 274 and 276, respectively, for RGB color mixing to generate light of a particular color, including white light. Almost any color in the spectrum may be generated by varying the intensity of the individual RGB colors. The volume 266 between the surface of the inflatable balloon 262 and the inner structure 264 acts as a light or color mixing chamber, which may be filled with helium or another appropriate gas to enable the inflatable balloon 262 to float. The outer surface of the inner structure 264 may comprise a reflective coating to aid mixing in the light or color mixing chamber 266. The inflatable balloon 262 may be made of a diffused and/or translucent material to provide better mixing and uniformity of the colors emitted from the light sources after passing through the outer surface of the balloon 262.

The optical fibers 270 are coupled to a light engine or light source (not shown) located externally to the apparatus 260 that generates and transmits light along the optical fibers 270. The number of optical fibers is not limited to the number shown in FIG. 2c and may comprise fewer or more than those shown. The apparatus 260 advantageously does not require any electronic circuitry to be located within or attached to the inflatable balloon 262, thus resulting in less weight and easier flotation.

In an alternative embodiment, color mixing can be performed externally to the apparatus 260 (e.g., at the light engine) and light of specific color/s can be delivered by the optical fibers 270.

The apparatuses 200, 230 and 260 can be used as pixels of selectable color in a full color static or dynamic video display.

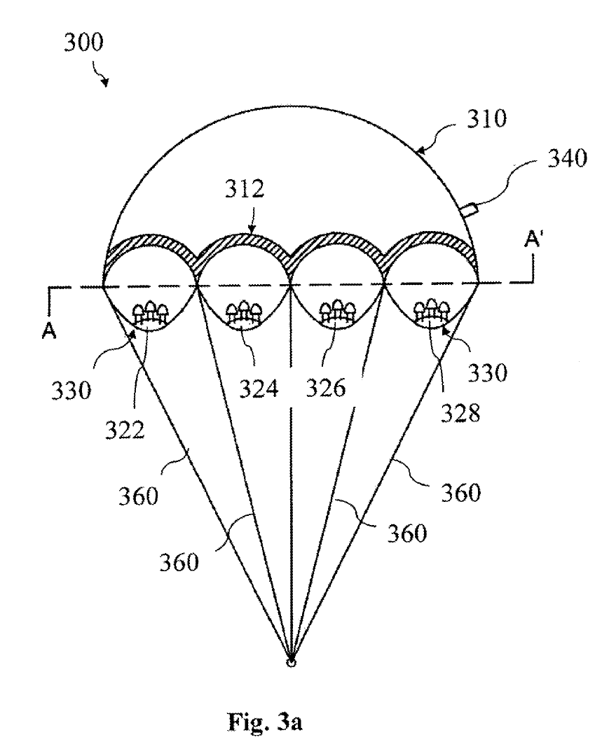

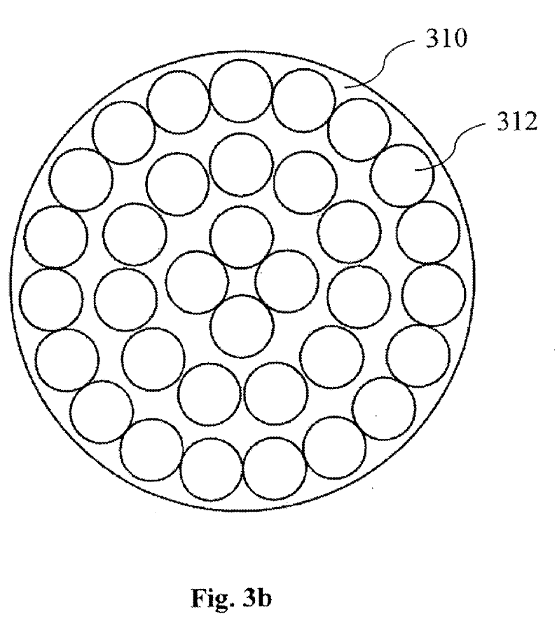

FIG. 3a shows an apparatus 300 comprising an inflatable balloon 310 to which multiple light sources 322, 324, 326 and 328 are coupled by means of lines 330. A port 340 is provided for inflation and deflation of the balloon 310. In one embodiment, the light sources 322, 324, 326 and 328 each comprise red, green and blue LEDs, respectively, for color mixing to generate light of a particular color, including white light. Clusters or distributed combinations of LEDs of each of the RGB colors can be used for increased light intensity. Mixing of light generated by the red, green and blue LEDs in each of the light sources 322, 324, 326 and 328 is performed by an electronic mixing circuit, whose electronic components are mounted with the LEDs on individual electronic circuit boards in each of the light sources 322, 324, 326 and 328. Alternatively, a single electronic mixing circuit may be used to perform mixing of light generated by the LEDs of each of the light sources 322, 324, 326 and 328. In another embodiment, the light sources 322, 324, 326 and 328 comprise color mixing chambers as described with reference to FIG. 2.

The underside of the balloon 310 provides one or more reflective surface/s 312 for reflecting light generated by the light sources 322, 324, 326 and 328. The reflective surface 312 may be adapted to assume a concave shape, which assists in focusing the light generated by the light sources 322, 324, 326 and 328. Alternatively, the reflective surface may be adapted to assume a convex shape, which assists in dispersing the light generated by the light sources 322, 324, 326 and 328. The light sources 322, 324, 326 and 328 are preferably directional such that a substantial percentage of light generated is reflected by the reflective surface/s 312. The reflective surface/s 312 may comprise a highly reflective coating applied to the external surface of the balloon 310. Alternatively, the entire balloon 310 may be produced from a reflective material. Another alternative is a separate portion of highly reflective material that may be attached to the balloon 310.

The apparatus 300 is restrained from floating away by means of the tether lines 360, which may be attached to an anchor point. The height above the ground of the apparatus 300 may be varied by adjusting the length of the tether lines 360 to illuminate a desired area below the apparatus 300.

The light sources 322, 324, 326 and 328 may be powered by means of a power cable routed along one or more of the tether lines 360 that electrically couples the light sources 322, 324, 326 and 328 to a power source (not shown). Power may be provided to the light sources 322, 324, 326 and 328 via inductive coupling for easier configuration and/or maintenance of the apparatus 300. The power source may provide power from the electricity supply, typically via a step-down transformer, from batteries, or from solar cells. Alternatively, the light sources 322, 324, 326 and 328 may be powered by solar cells mounted on or adjacent to the balloon 310 or by batteries located at the light source 320.

FIG. 3b is a sectional bottom view of the apparatus 300 of FIG. 3a, taken across section ‘A-A’. Thus, FIG. 3b shows circles of light reflected by the reflective surface 312 on the underside of the balloon 310. The reflected circles of light are generated by multiple light sources located below the reflective surface 312, but not shown in FIG. 3b. As each of the light sources comprise red, green and blue LEDs for color mixing, the apparatus 300 effectively comprises a full color display with each of the reflected circles of light appearing as a pixel to an observer below the apparatus 300. Thus, the apparatus 300 may be used to provide light of a selectable color, changing color sequences or a graphic display wherein the colors of each of the pixels are independently selectable.

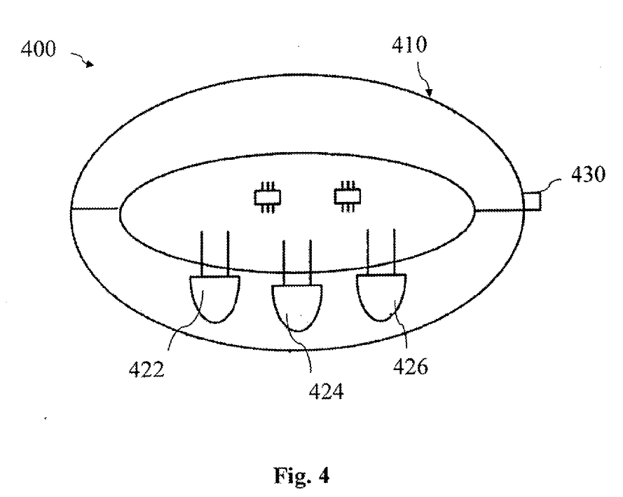

FIG. 4 shows an apparatus 400 comprising a light source disposed within a translucent inflatable balloon 410. The translucent material is preferably selected for minimal color distortion of light generated by the light source when refracted through the wall of the balloon 410. A port 430 is provided for inflation and deflation of the balloon 410. The inflatable balloon 410 comprises a helium-filled balloon and the light source comprises at least one red LED 422, one green LED 424 and one blue LED 426 for RGB color mixing to generate light of a particular color, including white light. Clusters or distributed combinations of LEDs of each of the RGB colors are typically used for increased light intensity. Mixing of light generated by the red, green and blue LEDs 422, 424 and 426 is performed by an electronic mixing circuit, whose electronic components are mounted with the LEDs 422, 424 and 426 on an electronic circuit board 440. Alternatively, the electronic mixing circuit may be located externally to the apparatus 400. In either case, power for operating the LEDs 422, 424 and 426 is provided via an electrically conductive power cable that enters the balloon 410 via an air-sealed port (not shown in FIG. 4). The apparatus 400 may comprise multiple such air-sealed ports for entry/exit of power cables when the apparatus 400 forms part of a display array. The apparatus 400 can be used to provide pixels of selectable color in a full color static or dynamic video display.

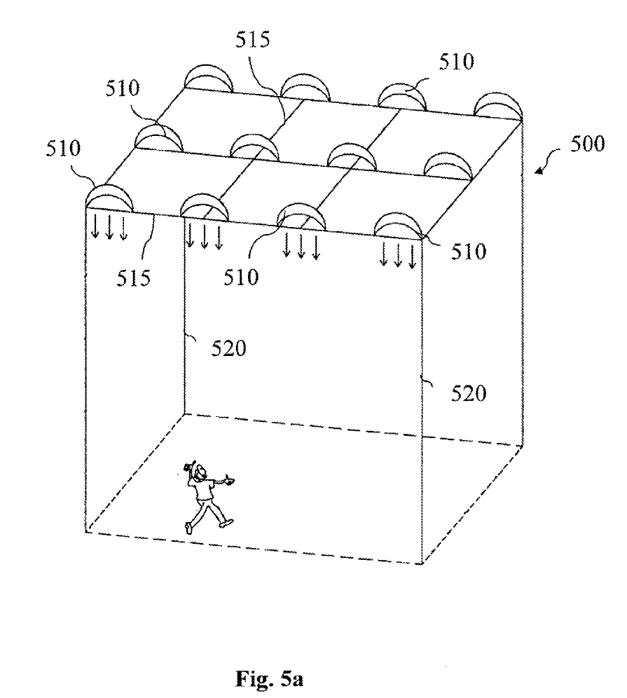

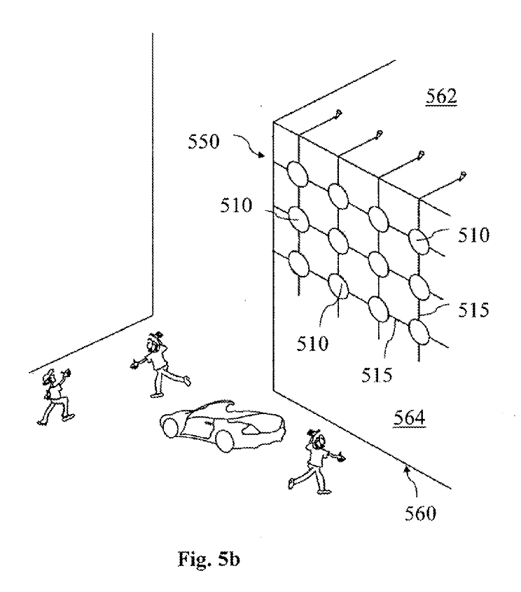

FIG. 5a shows a floating light system 500 comprising an array of floating light sources 510 interconnected by electrical and/or other interconnections 515. Each of the light sources 510 typically comprise an inflatable balloon with red, green and blue LEDs located in each balloon. For example, each of the light sources 510 may comprise an apparatus as shown in any of FIGS. 1 to 4.

The floating light system 500 may be used as an overhead lighting system to provide illumination for an area below. In this instance, the color of the light sources 510 may be controlled to provide light of a particular color or a sequence of lighting colors.

Alternatively, the floating light system 500 may comprise a full color static video display or a full color dynamic video display, in which each of the light sources 510 represent pixels in the video display. The colors of the light sources 510 are individually controllable using color mixing, as described hereinbefore, to selectively generate pixel colors in accordance with a desired scene to be displayed on the floating video screen display. Color mixing is performed by controlling the intensity of each of the RGB colors in order to generate a pixel of a particular required color.

The floating light system 500 may be secured to the ground and/or other fixed object/s by means of tether lines 520. The inflatable balloons may be individually or collectively inflated. For individual inflation, each balloon may be inflated via an inflation/deflation port on the balloon. For collective inflation, the inflation/deflation ports of each of the balloons are interconnected by air tubes. The balloons may thus be collectively inflated from a single point in the interconnected array of air tubes.

FIG. 5b shows a floating light system 550 attached to the side of a building as a static or dynamic video display. The floating light system 550 is generally as described hereinbefore in relation to the floating light system 500 of FIG. 5a. Apparatuses such as those described hereinbefore with reference to FIGS. 1 to 4 of the accompanying drawings may be used as the light sources 510. In certain cases (e.g. FIGS. 1, 2 and 3), the apparatuses may be required to be rotated through 90 degrees or are otherwise adapted to project generated light in a direction away from a wall or other structure used to support the display system 550. During installation, the light sources 510 are inflated and the display system 550 is secured to the roof 562 and/or wall 564 of a building 560. The balloons may either be inflated prior to installation of the display system 550 on the building 560 or after installation. In the latter instance, the balloons may be inflated via inflation/deflation tubes that form part of the interconnections 515 between the light sources 510. Alternatively, the interconnections 515 between the light sources 510 may comprise inflation/deflation tubes. In other installations, the display system 550 may alternatively be secured to and/or suspended from other types of structures such as scaffolding, billboards, vehicles, cranes, fences, walls and mountain sides.

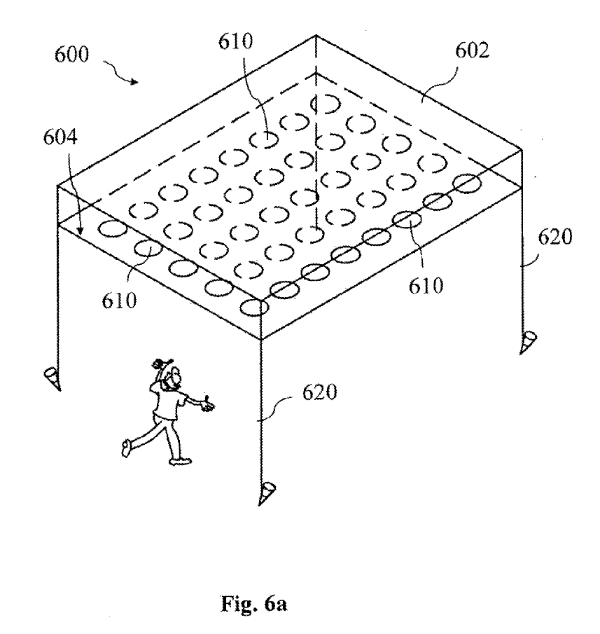

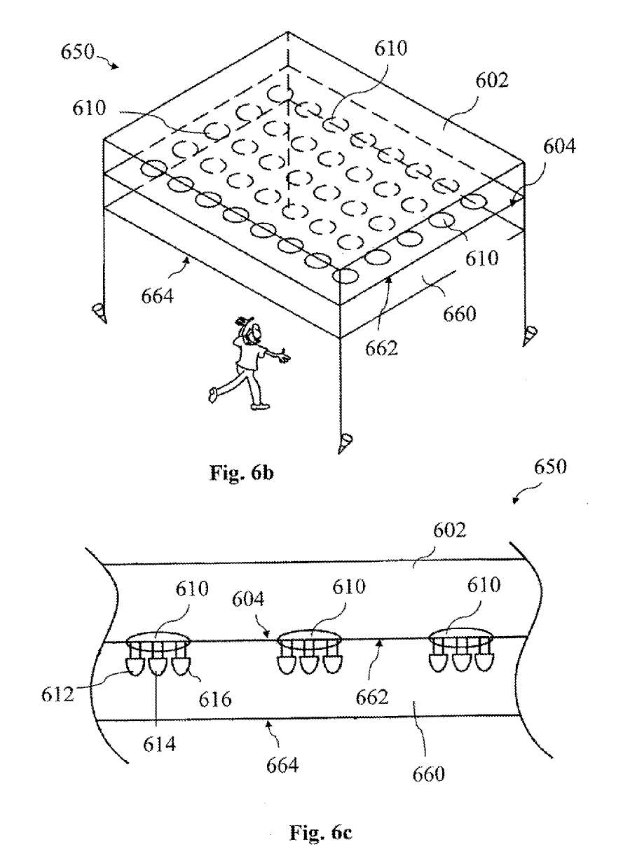

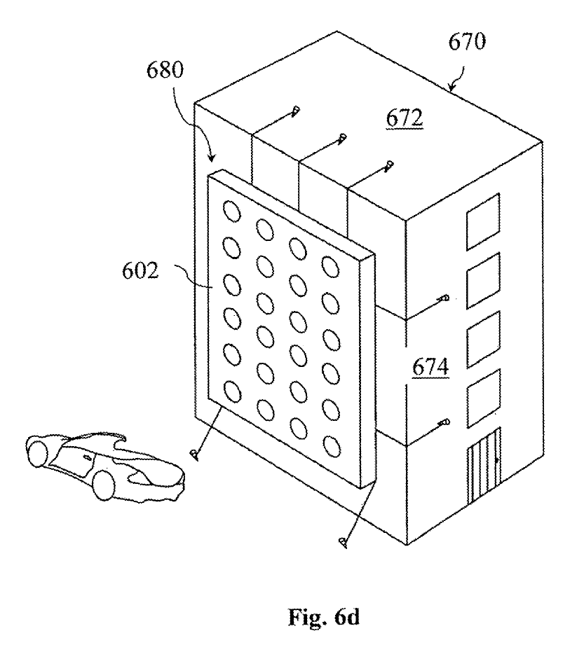

FIG. 6a shows a floating light system 600 comprising an inflatable balloon 602 in the inflated state with light sources 610 attached to the underside 604 of the inflatable balloon 602. Although shown to have a generally rectangular shape in FIG. 6a, the inflatable balloon 602 may comprise other shapes such as square, triangular and circular. The light sources 610 typically comprise one or more red, green and blue LEDs for color mixing. Each light source 610 may represent a pixel in a full color display provided by the floating light system 600.

The floating light system 600 may be used as an overhead lighting system to provide illumination for an area below. In this instance, the color of the light sources 610 may be controlled to provide light of a particular color or a sequence of lighting colors.

Alternatively, the floating light system 600 may comprise a full color static video display or a full color dynamic video display, in which each of the light sources 610 represent pixels in the video display. The colors of the light sources 610 are individually controllable using color mixing, as described hereinbefore, to selectively generate pixel colors in accordance with a desired scene to be displayed on the floating video screen display. Color mixing is performed by controlling the intensity of each of the RGB colors in order to generate a pixel of a particular required color.

The floating light system 600 may be secured to the ground and/or other fixed object/s by means of tether lines 620.

The light sources 610 may be attached to or detached from the inflatable balloon 602 for optical display configuration or maintenance purposes. The light sources 610 may be attached and detached using mechanical and electrical connection means. For example, the mechanical connection means may comprise a bayonet means, a threaded screw means, a friction fit means or any other known mechanical connection means. The electrical connection means may, for example, comprise a plug and socket, inductive coupling or any other known electrical connection means for providing electrical power to the light sources 610.

FIG. 6b shows a floating light system 650, as described hereinbefore in relation to the floating light system 600 of FIG. 6a. However, a color mixing chamber 660 is additionally located adjacent to the underside 604 of the inflatable balloon 602 for mixing the light generated by the light sources 610. The upper surface 662 and the four sides of the color mixing chamber 660 are reflective to promote color mixing. However, the lower surface 664 of the color mixing chamber 660 comprises a transparent or translucent material for transmitting light generated by the light sources 610.

A Brightness Enhancement Film (BEF), as described hereinbefore, may be used together with or in place of the lower surface 664 of the light mixing chamber 660 for enhancing the brightness of the mixed light.

FIG. 6c shows a cross-sectional side view of a portion if the floating light system 650 of FIG. 6b. Light sources 610 are shown attached to the underside 604 of the inflatable balloon 602. The light mixing chamber 660 is located adjacent to the underside 604 of the inflatable balloon 602 for mixing the light generated by the light sources 610. Either one or both of the upper 662 and lower 664 surfaces of the light mixing chamber 660 comprise a transparent or translucent material for transmitting light generated by the light sources 610. The upper 662 and/or lower 664 surfaces of the light mixing chamber 660 may comprise Brightness Enhancement Film (BEF).

FIG. 6d shows a floating light system 680 attached to the side of a building as a static or dynamic video display. The floating light system 680 is generally as described hereinbefore in relation to the floating light system 600 of FIG. 6a.

During installation, the inflatable balloon 602 is inflated and the floating light system 680 is secured to the roof 672 and/or wall 674 of a building 670. In other installations, the floating light system 680 may alternatively be secured to and/or suspended from other types of structures such as scaffolding, billboards, vehicles, cranes, fences, walls and mountain sides.

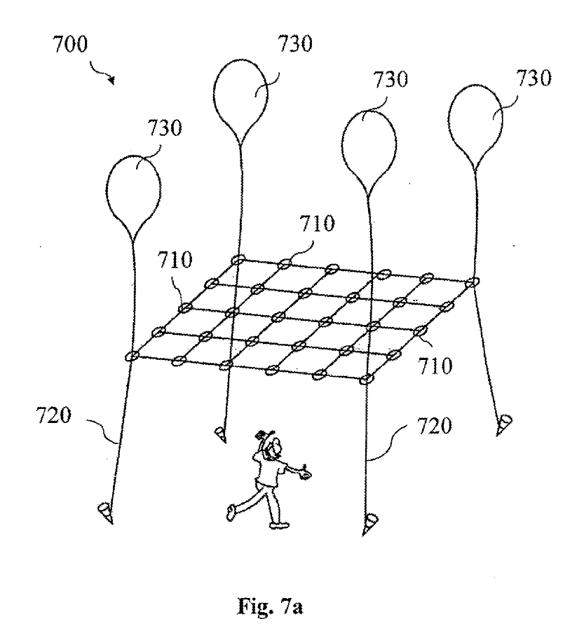

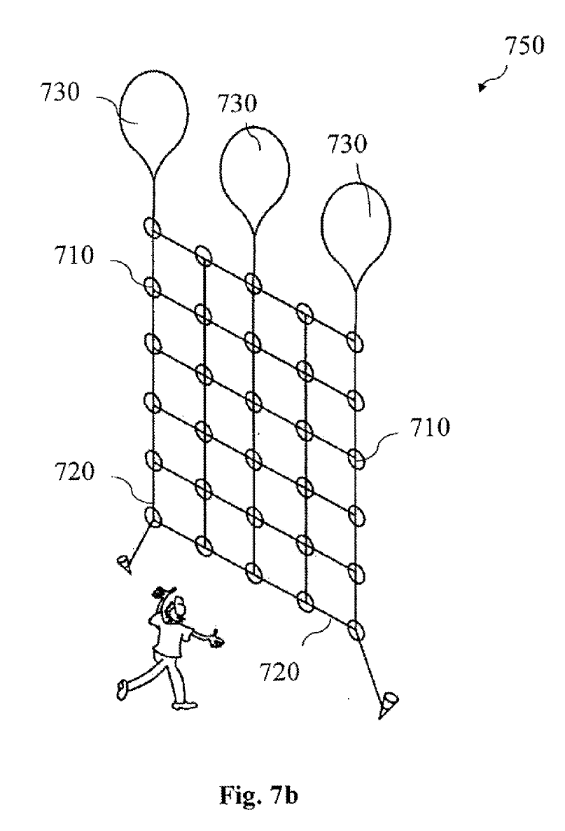

FIG. 7a shows a floating light system 700 comprising an array of interconnected light sources 710 suspended by floating balloons 730 and tethered to the ground or one or more fixed objects by tether lines 720. The light sources 710 typically comprise one or more red, green and blue LEDs for color mixing. Each light source 710 may represent a pixel in a full color display provided by the floating light system 700.

The floating light system 700 may be used as an overhead lighting system to provide illumination for an area below. In this instance, the color of the light sources 710 may be controlled to provide light of a particular color or a sequence of lighting colors.

Alternatively, the floating light system 700 may comprise a full color static video display or a full color dynamic video display, in which each of the light sources 710 represent pixels in the video display. The colors of the light sources 710 are individually controllable using color mixing, as described hereinbefore, to selectively generate pixel colors in accordance with a desired scene to be displayed on the floating video screen display. Color mixing is performed by an electronic mixing circuit that controls the intensity of each of the RGB colors in order to generate a pixel of a particular required color.

FIG. 7b shows a floating light system 750 comprising an array of interconnected light sources 710 suspended by floating balloons 730 and tethered to the ground or one or more fixed objects by tether lines 720. The floating light system 750 is disposed in a vertical plane and may be used as a static or dynamic video display.

In other installations, the floating light system 750 may alternatively be secured to structures such as scaffolding, billboards, vehicles, cranes, fences, walls and mountain sides.

The floating light system 750 is generally as described hereinbefore in relation to the floating light system 700 of FIG. 7a.

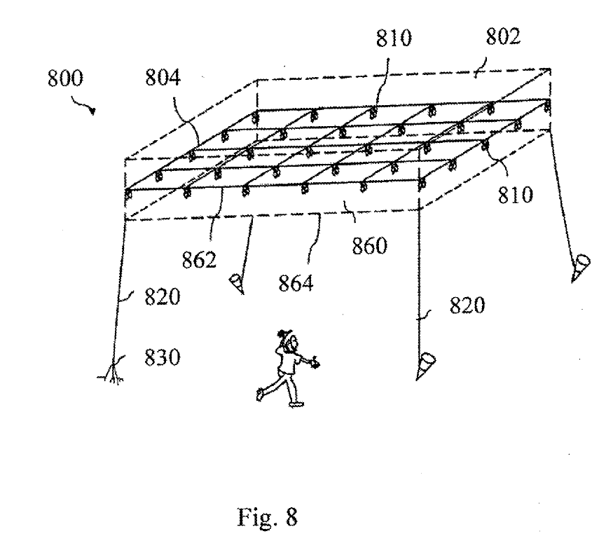

FIG. 8 shows a floating light system 800 comprising an inflatable balloon 802 in an inflated state with an array of optical fiber light sources 810 disposed on the underside 804 of the inflatable balloon 802. Although shown to have a generally rectangular shape in FIG. 8, the inflatable balloon 802 may comprise other shapes such as square, triangular and circular. Each optical fiber light source 810 comprises one or more red, green and blue fibers for color mixing. A light mixing chamber 860 is located adjacent to the underside 804 of the inflatable balloon 802 for mixing the light generated by the optical fiber light sources 810. Either one or both of the upper 862 and lower 864 surfaces of the light mixing chamber 860 comprise a transparent or translucent material for transmitting light generated by the optical fiber light sources 810. Brightness Enhancement Film (BEF), as described hereinbefore, may be used together with or in place of either or both of for the upper 862 and lower 864 surfaces of the light mixing chamber 860 for enhancing the brightness of the mixed light.

The floating light system 800 may be used as an overhead lighting system to provide illumination for an area below or as a full color static or dynamic video display, in which each of the optical fiber light sources 810 represent pixels in the video display. The colors of the optical fiber light sources 810 are individually controllable to perform color mixing to selectively generate pixel colors in accordance with a desired scene to be displayed on the floating video screen display. Control of the color and intensity of the optical fiber light sources 810 is performed by a light engine (not shown) that generates and injects light of particular colors to the optical fibers 830 for delivery to the optical fiber light sources 810. The optical fibers 830 may be routed together with one or more of the tether lines 820, which are used to secure the floating light system 800 to the ground and/or other fixed object/s or anchors. The floating light system 800 may also be attached to the side of a building or other support structure as a static or dynamic video display as described hereinbefore.

When used as a static or dynamic video display, the individual light sources or pixels of the floating light systems described hereinbefore are controlled by an electronic display controller (not shown in the figures). Control signals from the electronic display controller to the light sources or light engine may be provided according to a standard format such as DMX format, DALI format and digital or analog video format. DMX is a high-speed digital data transmission format used by control units to communicate with lights in display systems. DALI comprises a series of 2-byte commands used to control DALI compatible lighting and other electrical loads at remote locations. Alternatively, any proprietary format may be used including a pulse width modulation (PWM) scheme. The control signals or commands may be transmitted to the individual light sources by any known transmission means including electrical wires, optical fibers, power line modulation and wireless transmission.

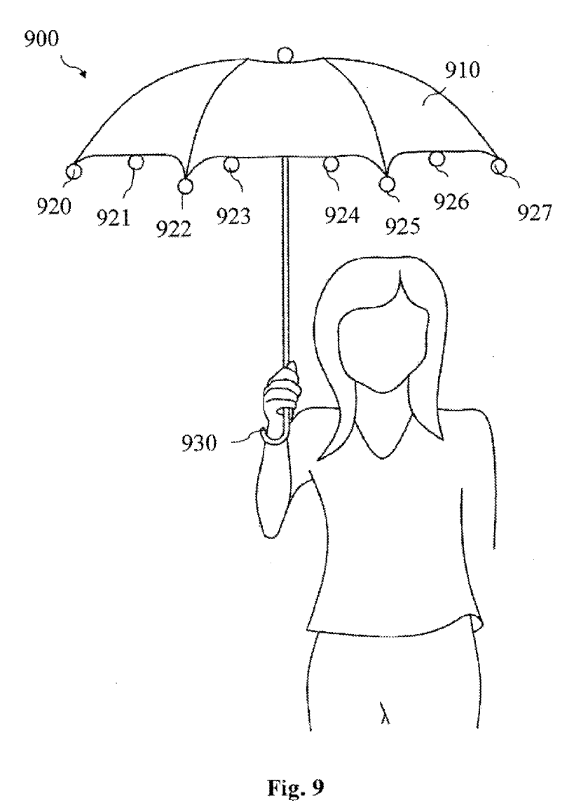

FIG. 9 shows an inflatable illuminated umbrella 900. The umbrella comprises one or more helium-filled compartments 910 and a number of LEDs 920 . . . 927, which are typically mounted on the outer rim of the umbrella 900. The LEDs 920 . . . 927 are powered by batteries, preferably mounted in the handle 930 of the umbrella 900. An automatic inflation device may also be mounted in the handle 930 of the umbrella 900.

Inductive coupling of the power supply and/or control signals may be used in any of the embodiments described herein for easier configuration and maintenance of the light sources.

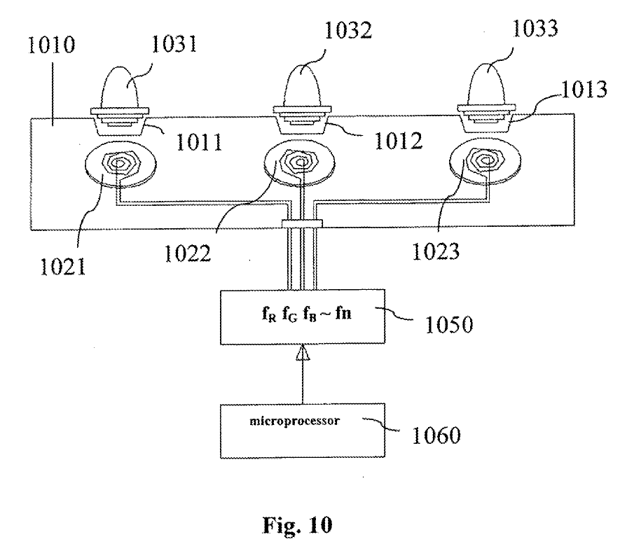

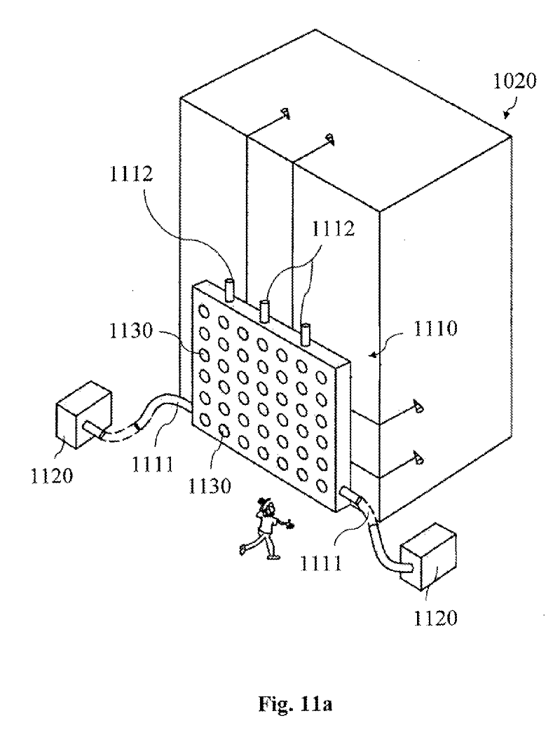

FIG. 10 shows a portion of an inflatable balloon 1010 having recesses 1011, 1012 and 1013 in the outer surface thereof for detachably attaching light sources by way of a press-fit. The recesses may, for example, be molded into the material of the inflatable balloon 1010. Power is transferred to the light sources via inductive coupling between the inductors 1021, 1022 and 1023, which are located within the inflatable balloon 1010 and are electrically connected to a power source 1050. The light sources 1031, 1032 and 1033 each comprise a base, which may optionally be made from a flexible material such as rubber for facilitating a press-fit into recesses 1011, 1012 and 1013. The bases of light sources 1031, 1032 and 1033 comprise a number of concentric rings of stepped diameter to enable press-fitting into recesses of different diameters. An inductor embedded in the base of each of the light sources 1031, 1032 and 1033 is electrically connected to the actual light source element/s in light sources 1031, 1032 and 1033 for receiving power from the inductors 1021, 1022 and 1023, respectively. It is preferable that the inductors in the bases of light sources 1031, 1032 and 1033 and the corresponding inductors 1021, 1022 and 1023 are disposed in close proximity and substantially parallel to each other to maximize power transfer.

The light sources 1031, 1032 and 1033 as shown in FIG. 10a comprise red, green and blue LEDs, respectively. The light sources 1031, 1032 and 1033 may alternatively each comprise clusters of LEDs. Color mixing can be performed by independently controlling the RGB colors in a pixel using separate inductive power couplings for the individual colors.

The inductors in FIG. 10 are shown as two-dimensional helical coils, which may, for example, comprise a coil of wire or an etched trace on a printed circuit board (PCB). However, other appropriate forms or geometries may be practiced.

Other means for attaching the light sources 1031, 1032 and 1033 to the inflatable balloon 1010 may alternatively be used in place of the press-fit system described hereinbefore. For example, the inflatable balloon 1010 may comprise threaded attachment bases that enable the light sources to be fitted by way of a screw or bayonet fitting and that prevent the gas inside the inflatable balloon escaping even when a light source is removed and/or replaced.

Inductive coupling of the power supply is performed using signals fR, fG and fB generated by a power oscillator 1050, which is controlled by a microprocessor 1060 to provide a narrowband resonance coupling. The particular voltages and frequencies used are dependent on the current required to drive the particular light sources (e.g., different types of LEDs). The brightness of the individual red, green and blue LEDs is controlled by varying the currents flowing through the LEDs. The currents are generated by the power oscillator 1050, under control of the microprocessor 1060, according to the formula:

I=V_{RMS}/(2?FL)
where:
I is the current generated for driving one or more LED/s of a particular color,
V_{RMS} is the RMS voltage of the signal used to drive the LED/s,
F is the frequency of the signal used to drive the LED/s, and
L is the lumped inductance across the terminals of an inductive coupling coil driven by the power oscillator 1050.

An electronic circuit or microcontroller may alternatively be used for controlling the power oscillator 1050. The inductors 1021, 1022 and 1023 may be individually or collectively energized by the power oscillator 1050. The power oscillator 1050 and microprocessor 1060 are shown externally to the inflatable balloon 1010 in FIG. 10 but may be disposed within the inflatable balloon 1010 in alternative embodiments.

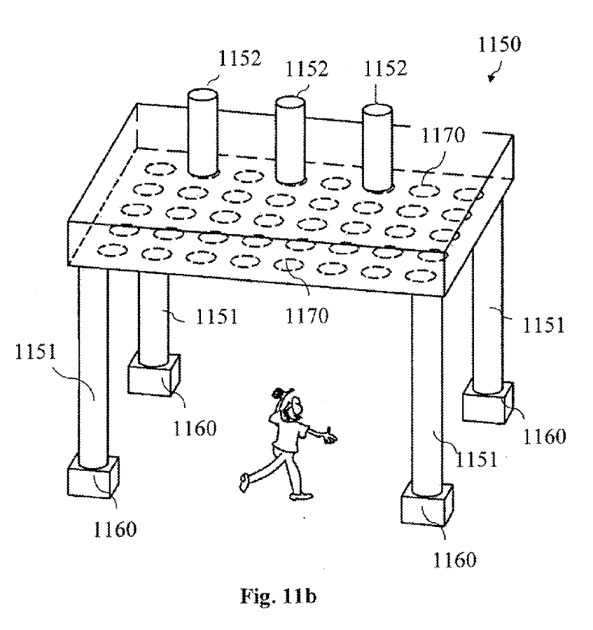

FIG. 11a shows an apparatus 1110 attached to a building or other structure 1020. The apparatus 1110 is similar to the inflatable balloons described hereinbefore, however, the apparatus 1110 does not comprise an air-sealed compartment or pocket. Rather, the apparatus 1110 comprises an unsealed compartment or pocket that is inflated by continuously pumping air or other gas through the apparatus 1110 in a manner similar to a “jumping castle”, commonly used at children's parties. Air or other gas is pumped into the apparatus 1110 through inlets 1111 by one or more pumps 1120 and escapes through outlets 1112. Any reasonable number of inlets and outlets may be practiced. A number of light sources 1130 are disposed internally or externally to the apparatus 1110, for example, in accordance with any of the embodiments described hereinbefore. In particular, the light sources may comprise RGB LED pixels to provide a full-color video display as described hereinbefore. The light sources 1130 are supported in an operational configuration only when the apparatus 1110 is inflated, as shown in FIG. 11a (i.e., for providing a display). When not inflated, the apparatus 1110 may conveniently be folded or rolled up.

FIG. 11b shows another apparatus 1150, similar to the apparatus of FIG. 11a, that also comprises an un-sealed compartment or pocket that is inflated by continuous airflow. Air or other gas is pumped through the legs 1151 of the apparatus 1150 by one or more air pumps 1160 and escapes through outlets 1152. Any reasonable number of inlets and outlets may be practiced. A number of light sources 1170 are disposed internally or externally to the apparatus 1150, for example, in accordance with any of the embodiments described hereinbefore. In particular, the light sources may comprise RGB LED pixels to provide a full-color lighting display or a full-color video display as described hereinbefore. The light sources 1170 are supported in an operational configuration only when the apparatus 1150 is inflated, as shown in FIG. 11b (i.e., for providing overhead lighting or an overhead display). When not inflated, the apparatus 1150 may conveniently be folded or rolled up. The embodiments shown in FIGS. 11a and 11b are advantageously quickly and easily deployed. Furthermore, the continuous airflow acts as an air-cooling system for dissipating heat generated by the light sources and associated electronic circuits. The heat can be more uniformly distributed over a larger area which means that the color and intensity consistency (i.e., evenness of color and brightness) over a large display area are improved.

Embodiments described hereinbefore comprise inflatable balloons, which may be produced from materials such as polyvinylchloride (PVC), polyethylene (PE), polycarbonate (PC) and acrylic material. However, any other known and suitable material may be used. In embodiments where the light sources are located externally to the inflatable balloon, it is unnecessary to construct the balloon from a transparent or translucent material.

Certain embodiments require the external surface of the inflatable balloon to assume and maintain a particular shape (e.g., concave and convex). Improved retention of the particular shape can be achieved by applying a hardening material (e.g., a polymer coating) to the material the balloon is constructed from or inserting a lightweight frame into the lining of the inflatable balloon (e.g., aluminum or carbon fiber).

Interconnections between light sources in the floating light systems described hereinbefore may comprise electrically conductive cable or wire for the transmission of power and/or control signals and/or air tubes for inflation of the balloons.

The number of light sources used in the floating light systems described hereinbefore is not limited to the number shown in the accompanying drawings but may be determined in accordance with the physical size and/or resolution required for a particular floating light system implementation.

Various apparatuses and systems that provide inflatable lighting and displays have been described hereinbefore. Advantageously, certain of the apparatuses and systems described hereinbefore float, or their weight is at least reduced, thus lessening the loading requirements for supporting such apparatuses and systems. Other systems described hereinbefore rely on continuous airflow to maintain the operational position of the lighting or display system and result in relatively quicker and easier deployment of the system.

Some applications of the apparatuses and systems described herein include illumination, signaling, message displays and graphics displays.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features and integers referred to in respect of a particular embodiment may optionally form part of any of the other embodiments, if appropriate.

The light sources in the preferred embodiment as described above include LED or optical fibers. However, one with ordinary skill in the art should realize that other kinds of illuminating devices can also be used, such as Incandescent light or halogen light. All these illuminating devices can be summarized as light elements, and light element as described herein can be referring to a single device or a group of devices.

The inflatable structures in the previous embodiments are described as being made of a diffused and/or translucent material. These materials can be directly or indirectly in contact with ambient air or the inflation gas such as helium filled in the inflatable structure, since there may be other reflective materials coated on the surface of the inflatable structure such as the BEF.

The present invention, in another aspect, is an inflatable lighting apparatus that includes an inflatable structure, a plurality of light sources disposed on the exterior of the inflatable structure, and at least one mixing device. The mixing device mixes light emitted by the plurality of light sources. The inflatable apparatus provides indirect viewing for a viewer. Each light source represents a pixel in video display.

According to another aspect of the present invention, an inflatable lighting apparatus includes an inflatable structure and a plurality of light sources. The inflatable structure includes a housing defining a gas chamber enclosing a hollow space. The gas chamber is adapted to receive inflation gas therein. The housing includes an interior surface and an exterior surface. The interior surface is in contact with the gas chamber. The exterior surface is in contact with the ambient air. The housing further defines an opening for access between exterior ambience and the hollow space. The exterior surface further includes an inward exterior surface disposed within an outward exterior surface. The inward exterior surface encloses the hollow space and separates the gas chamber and the hollow space. The plurality of light sources is disposed on the inward exterior surface of the housing. The inflatable structure mixes light emitted by the plurality of light sources. The inflatable apparatus provides indirect viewing for a viewer. The light sources represent pixels in video display.

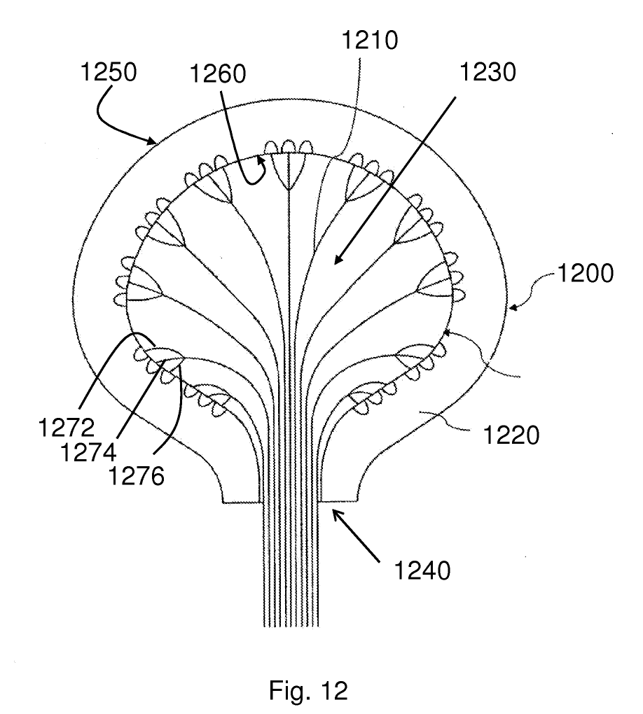

In a preferred embodiment as shown in FIG. 12, the inflatable apparatus includes an inflatable structure 1200 and a plurality of optical fibers 1210. The inflatable structure 1200 includes a housing defining a gas chamber 1220 enclosing a hollow space 1230. The gas chamber 1220 is adapted to receive inflation gas such as helium therein. The housing includes an interior surface 1260 and an exterior surface 1250. The interior surface 1260 is in contact with the gas chamber 1220. The exterior surface 1250 is in contact with the ambient air. The housing further defines an opening 1240 for access between exterior ambience and the hollow space 1230. The exterior surface further includes an inward exterior surface 1250 disposed within an outward exterior surface 1260. The inward exterior surface encloses the hollow space 1230 and separates the gas chamber 1220 and the hollow space 1230. The ends of the plurality of optical fibers 1210 are disposed on the inward exterior surface of the housing 1230.

The shape of the inward exterior surface may be maintained or improved by a light-weight frame that is slightly elastic in nature, for example, made from light metal wires or polymer wires such as Nylon. The ends of the optical fibers 1270 comprise red, green and blue light sources 1272, 1274 and 1276, respectively, for RGB color mixing to generate light of a particular color, including white light. Almost any color in the spectrum may be generated by varying the intensity of the individual RGB colors. The gas chamber 1220 between the outward exterior surface of the inflatable structure 1200 and the inward exterior surface acts as a light or color mixing chamber, which may be filled with helium or another appropriate gas to enable the inflatable structure 1200 to float. The interior surface of the housing of inflatable structure 1200 next to the inward exterior surface may comprise a reflective coating to aid mixing in the light or color mixing chamber 1220. The inflatable structure 1200 may be made of a diffused and/or translucent material to provide better mixing and uniformity of the colors emitted from the light sources after passing through the outward exterior surface of the inflatable structure 1200.

The material for making the inflatable structure in the exemplary embodiments of the present invention can be either elastic or rigid. For a rigid material, it could be used in making compartments as exemplified in FIG. 9. For elastic material, balloon is an example where elastic material is used.

In the preferred embodiments described above, mixing of the individual RGB colors of the light emitted by the three lighting elements is performed by a mixing device. Exemplars of mixing devices are the reflective layer, condensing lens or translucent layer. When viewed afar, the mixing device fuses the light intensities of individual RGB colors so the viewer perceives a single dot. The single color dot then represents a pixel in the image or video display. Therefore, the RGB colors are mixed first before the viewer can see it and it is thus an indirect way to show to the external viewer. This method of providing viewing to the external viewer by the inflatable apparatus is also called “indirect viewing”.

In another implementation, the inflation gas filled in the inflatable structure can further be mixed with other kind of gases with different colors, such that the light passing through the mixing chamber can have a mixed color effect. For example, if the inflation gas such as helium is mixed with a red-color gas, the color of the single color dot as shown to the external viewer is reddened. Alternatively, yellow-color gas can be used to produce a “sunset” effect for the display. The density of the colored gas filled in the inflatable structure can also be adjusted so as to vary the diffusion intensity of the mixing chamber.

In another embodiment of the present invention, an inflatable lighting system includes a plurality of inflatable lighting panels. Such lighting panels, also called sub-panels, have a structure similar to the individual inflatable apparatus as described in the preferred embodiment described above. Each lighting panel is an individual display panel which can provide all the functions if it is used solely. However, when necessary the plurality of lighting panels can be arranged as an array to form a combined display panel. This combined display panel provides a much larger viewing area than an individual light panel. The display of each sub-panel in the combined display panel will be controlled and coordinated by an external control circuit, for example a computer system. In the present invention, a self-lifting, light-weight backbone frame structure is provided to combine individual sub-panels. This is suitable for fast-deployment of a large display panel.

The present invention in one aspect is therefore the inflatable system described above that allows indirect viewing. By using mixing devices before the light emitted by the light sources leaves the inflatable apparatus, the external viewer will view each pixel as a single color dot rather than three close and distinct color dot by conventional means. This is especially true for the viewer located closely to the inflatable apparatus.

What is claimed is:

1. A inflatable lighting apparatus comprises:
a) a inflatable structure;
b) a plurality of light sources disposed on the exterior of said inflatable structure; and
c) at least one mixing device, said mixing device mixing light emitted by said plurality of light sources;
wherein said inflatable apparatus providing indirect viewing for a viewer.

2. The inflatable lighting apparatus of claim 1, wherein said light source further comprises a red light element, a blue light element and a green light element, wherein the output intensity of said light elements being individually controllable; the light emitted by each light element being mixed by said mixing device to form a single-color dot representing a pixel in video display.

3. The inflatable lighting apparatus of claim 2, wherein said inflatable lighting apparatus comprises a plurality of said mixing devices, each said mixing device corresponding to one of said light sources and mixing light emitted by said one of light sources.

4. The inflatable lighting apparatus of claim 3, wherein said mixing devices are arranged in a planar configuration; said light sources are arranged in a planar configuration.

5. The inflatable lighting apparatus of claim 4, wherein each said mixing device is a reflective surface in a concave shape; said mixing device being located directly above said one of light sources.

6. The inflatable lighting apparatus of claim 2, wherein said mixing device further comprises a reflective surface and an optical lens for transmitting light reflected by said reflective surface.

7. The inflatable lighting apparatus of claim 2, wherein said light sources are detachably attached to said inflatable structure and inductively coupled to a power source.

8. The inflatable lighting apparatus of claim 7, wherein the base of said light source comprises a number of concentric rings of stepped diameter to enable press-fitting into a recess on said exterior of said inflatable structure.

9. The inflatable lighting apparatus of claim 2, wherein said inflatable structure further comprises a plurality of balloons; said plurality of light sources being interconnected and arranged as an array which is suspended by said plurality of balloons.

10. The inflatable lighting apparatus of claim 1, wherein said inflatable structure is filled with colored gas.

11. A inflatable lighting apparatus comprises:
a) an inflatable structure comprising a housing defining a gas chamber enclosing a hollow space, said gas chamber receiving inflation gas therein; said housing comprising an interior surface and an exterior surface; said interior surface being in contact with said gas chamber; said exterior surface being in contact with the ambient air; said housing further defining an opening for access between exterior ambience and said hollow space; said exterior surface further comprising an inward exterior surface disposed within an outward exterior surface, said inward exterior surface enclosing said hollow space and separating said gas chamber and said hollow space; and
b) a plurality of light sources disposed on said inward exterior surface of said housing, said inflatable structure mixing light emitted by said plurality of light sources; and;
wherein said inflatable apparatus providing indirect viewing for a viewer; said light sources representing pixels in video display.

12. The inflatable lighting apparatus of claim 11, wherein said light sources are optical fibers; the end of said optical fiber being located by said inward exterior surface of said inflatable structure which is maintained by a light-weight frame.

13. The inflatable lighting apparatus of claim 12, wherein said inner structure further comprises a plurality of condensing lens; the end of each said optical fiber being placed with said condensing lens, such that said condensing lens focuses light generated by said optical fiber.

14. A inflatable lighting system comprises a plurality of inflatable lighting panels; each said light panel further comprising:
i) a inflatable structure;
ii) a plurality of light sources disposed on the exterior of said inflatable structure; and
iii) at least one mixing device, said mixing device mixing light emitted by said plurality of light sources;
wherein said plurality of lighting panels are arranged as an array to form a combined display panel.
